(19) United States
(12) Patent Application Publication
(10) Pub. No.: US 2015/0109126 A1
(43) Pub. Date: Apr. 23, 2015

(54) Child Monitoring System

(71) Applicant: Morgan Crawford, Columbus, OH (US)

(72) Inventor: Morgan Crawford, Columbus, OH (US)

(21) Appl. No.: 14/515,173

(22) Filed: Oct. 15, 2014

Related U.S. Application Data
(60) Provisional application No. 61/892,059, filed on Oct. 17, 2013.

(51) Int. Cl. G08B 21/02

(52) U.S. Cl. CPC G08B 21/0269
USPC 340/539.13

(57) ABSTRACT

A child monitoring system for helping parents to monitor their children. The system includes a parental unit that preferably includes a band with a housing thereon so as to resemble a watch. The system further includes one or more child units that preferably resemble a bracelet. The parental unit includes a microprocessor, a wireless transceiver, an alarm, a vibration motor, a speaker, a microphone, and a display. The child unit includes a microprocessor, a transceiver, a camera, a speaker, a microphone, and a GPS chip. The parental and child units are paired so that the parental unit can display the location of the child unit as determined by the GPS chip therein. Further, the parental and child units can be used to communicate with one another. The child units may include a lock thereon that can only be locked or unlocking by means of the parental unit.

### CROSS REFERENCE TO RELATED APPLICATION

This application claims the benefit of U.S. Provisional Application No. 61/892,059 filed on Oct. 17, 2013. The above identified patent application is herein incorporated by reference in its entirety to provide continuity of disclosure.

### BACKGROUND OF THE INVENTION

1. Field of the Invention

The present invention relates to a child monitoring system for use by parents or guardians. The system includes a parental unit to be worn by an adult, and a child unit to be worn by a child. The child unit includes a GPS chip and means for communicating with the parental unit. The parental unit includes a display for displaying the location of the child unit, and means for communicating with the child unit.

It is important for parents and guardians to closely monitor their children so as to prevent the children from becoming lost. This is particularly true in crowded areas such as shopping malls, airports, beaches, and other public areas. If a child becomes lost, the child may not be able to find his or her way back to his or her parents or guardians. Further, the child may become scared and anxious if they are separated from their parents for too long. A child may even be kidnapped if left unattended.

Parents may have difficulty keeping track of their children in a crowded public place. Children may not be old enough to use a mobile device, such as a cell phone, for communicating with their parents. Thus, the parent must constantly monitor the child in order to prevent the child from becoming lost. However, it can be difficult or impossible for a parent to monitor a child at all times. Thus, a device that allows a parent and a child to remain in contact and that allows the parent to monitor the child's location is desired.

The present invention provides a child monitoring system that includes a parental unit and a child unit. The parental unit includes a band having a housing thereon, wherein the band can be worn around a user's wrist so as to resemble a watch. The housing includes a microprocessor, a display, an alarm, a speaker, a microphone, a wireless transceiver, and a vibration motor. The parental unit is paired with a child unit that comprises a bracelet having a microprocessor, a wireless transceiver, a camera, a speaker, a microphone, and a GPS chip therein. The parental unit is adapted to display the location of the child unit as determined by the GPS chip thereon. Further, the parental unit and child unit can be used so that the users can communicate with one another. The child unit may further include a lock thereon that is adapted to be locked or unlocked by means of the parental unit so as to prevent the child unit from being removed from a child's wrist.

1. Description of the Prior Art

Devices have been disclosed in the prior art that relate to child monitoring systems. These include devices that have been patented and published in patent application publications. These devices generally relate to child monitoring systems that determine the child's proximity to the parent or guardian. The following is a list of devices deemed most relevant to the present disclosure, which are herein described for the purposes of highlighting and differentiating the unique aspects of the present invention, and further highlighting the drawbacks existing in the prior art.

One such device, U.S. Patent Application Publication Number 2004/0046658 to Turner et al. discloses a child monitoring system. The system includes a transceiver worn on the wrist of a guardian and a transceiver worn on the wrist of a child. The transceivers send signals and determine the strength of an incoming signal. If the strength of a child's signal is weak, indicating that the child is out of range, an alarm on the guardian's transceiver sounds. The transceiver can include a visual indication of the child's location and the user may adjust the range of the device. Thus, Turner et al. discloses a child monitoring system, but fails to disclose a child monitoring system having parental units and child units that include speakers, cameras, vibration motors, microphones, and additional functionality.

U.S. Pat. No. 7,511,627 to Holoyda discloses a child locator system. The system includes a master unit to be worn by a parent and a monitored unit to be worn by a child. The master unit includes an alarm that sounds when the monitored unit is moved beyond a predetermined distance from the master unit. The alarm can include audible or visible notifications. The master unit further includes a directional antenna for determining the position of the monitored unit. The monitored unit may deliver voice data to a speaker on the monitored unit. Thus, Holoyda discloses a child monitoring system, but fails to disclose a system having a parental unit with a microphone, a display, a speaker, an alarm, and a transceiver for communicating with a child unit. Further, Holoyda does not disclose a child unit having a lock thereon that can be unlocked only by means of the parental unit.

U.S. Pat. No. 7,259,671 to Ganley et al. discloses a proximity system including a first mobile transceiver and a second mobile transceiver. The transceivers are in communication via an RF link wherein the second mobile transceiver includes an alarm indication when the first transceiver has moved a predetermined distance therefrom. The first transceiver is worn by a monitored person, such as a child, and the second transceiver can be worn by a parent. Thus, Ganley et al. discloses a proximity alert system, and fails to disclose a child monitoring system having GPS tracking capabilities and audio and visual communication capabilities.

U.S. Patent Application Publication Number 2006/0009238 to Stanco et al. discloses a communication and locating system. The system includes a mobile communication device that is adapted to communicate with a global positioning system and a cell triangulation system. The system is adapted to determine the authorization of a user and to determine the location of the communication device. Thus, Stanco et al. discloses a locating device, but fails to disclose a parental unit that is paired with a child unit for monitoring and communicating with a child wearing the child unit.

Finally, U.S. Pat. No. 8,508,361 to Paolini discloses a personal locator device. The locator device includes a housing having a processor, a GPS system, a mobile communication unit, and a power source. A transmitter is adapted to provide a distress signal to a remote entity identifying the personal locator device. The device does not include a keypad and can be used in areas in which mobile telephones are prohibited. Thus, Paolini discloses a communication device having a GPS system, but fails to disclose a child monitoring system having a parental unit wirelessly paired with a child unit.

These prior art devices have several known drawbacks. Devices in the prior art relate to child monitoring systems adapted to monitor the proximity of the child to the parent, and that provide an alarm when the child exceeds a predetermined distance from the parent. These systems, however, do not provide a GPS chip embedded in the child unit for allowing a parent to accurately determine the child's location. Further, these systems lack communication means allowing the user to communicate with the child. Additionally, the prior art devices do not provide a means for preventing a child from removing the child unit and to prevent others from tampering with the child unit.

In light of the devices disclosed in the prior art, it is submitted that the present invention substantially diverges in design elements from the prior art and consequently it is clear that there is a need in the art for an improvement to existing child monitoring systems. In this regard the instant invention substantially fulfills these needs.

### SUMMARY OF THE INVENTION

In view of the foregoing disadvantages inherent in the known types of child monitoring system now present in the prior art, the present invention provides a new child monitoring system wherein the same can be utilized for providing convenience for the user when determining the location of a child and communicating with a child.

It is therefore an object of the present invention to provide a new and improved child monitoring system that has all of the advantages of the prior art and none of the disadvantages.

It is another object of the present invention to provide a child monitoring system comprising a parental unit to be worn by a parent and a child unit to be worn by a child, wherein the parental unit and child unit are wirelessly paired and are able to communicate with one another.

Another object of the present invention is to provide a child monitoring system wherein said child unit includes a GPS chip that allows the parental unit to determine the location of the child unit.

Yet another object of the present invention is to provide a child monitoring system wherein the parental and child units include speakers, microphones, and wireless transceivers for allowing the parent and child to communicate with one another.

Another object of the present invention is to provide a child monitoring system wherein the child unit includes a lock thereon that prevents the child from removing the bracelet or tampering therewith, wherein the lock can be opened by means of the parental unit.

A further object of the present invention is to provide a child monitoring system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the parental unit of the present invention.

FIG. 2 shows a perspective view of an embodiment of the child unit of the present invention.

FIG. 3 shows a schematic diagram of the electrical components of the parental unit of the present invention.

FIG. 4 shows a schematic diagram of the electrical components of the child unit of the present invention.

### DETAILED DESCRIPTION OF THE INVENTION

Reference is made herein to the attached drawings. Like reference numerals are used throughout the drawings to depict like or similar elements of the child monitoring system of the present invention. For the purposes of presenting a brief and clear description of the present invention, the preferred embodiment will be discussed as used for monitoring a child and communicating with the child. The figures are intended for representative purposes only and should not be considered to be limiting in any respect.

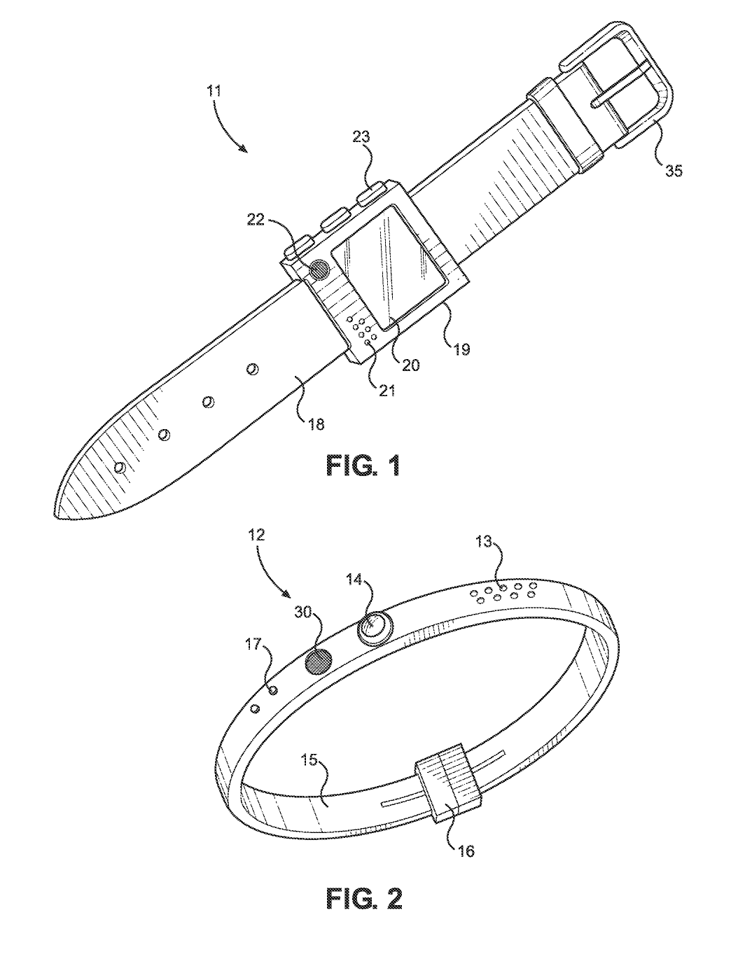

Referring now to FIG. 1, there is shown a perspective view of an embodiment of the parental unit of the present invention. The present invention provides a child monitoring system comprising at least one parental unit 11 that is paired with at least one child unit such that the parental unit 11 and child unit can wirelessly communicate with one another. The parental unit 11 is adapted to be worn or carried by a parent, guardian, or caretaker of a child. Preferably, the parental unit 11 comprises a watch-like device having a housing 19 disposed on a strap 18 that can be adjustably fastened on a user's wrist. The strap 18 includes a fastener 35, such as a buckle, thereon for securing the parental unit 11 to the user's wrist. This helps to ensure that the parental unit 11 is easily accessible to the user, and helps to prevent the user from forgetting or losing the parental unit 11.

The parental unit 11 comprises a microprocessor, a wireless transceiver, a display 20, an alarm, a speaker 21, and a microphone 22. The wireless transceiver is adapted to communicate with a transceiver of a child unit. The wireless transceiver can operate via WiFi, a Bluetooth connection, or radio frequency signals, among other wireless communication means known in the prior art. The parental unit 11 is adapted to enclose a power source, such as one or more batteries therein.

The display 20 can be a liquid crystal display (LCD) or a light-emitting diode (LED) display, among others. The display 20 is adapted to display information regarding the location of the child unit. The display 20 may show a map with an icon showing the child unit's location thereon. Alternatively, the display 20 may show the coordinates of the child unit. The display 20 may also show the distance between the parental unit 11 and the child unit. Further, in some embodiments the display 20 is adapted to display live video captured by a camera on the child unit. In this way, the user can see the child in order to determine the child's location and whether the child is in danger.

The alarm of the parental unit 11 can provide various types of alerts for the user. The parental unit 11 may include a vibration motor for providing a vibrating alert. The alarm may provide an audible sound such as a tone or beep via the speaker on the parental unit. Further, the display 20 may illuminate or flash in order to alert the user. The alarm may sound when the user of a child unit operates a control thereon sending a signal to the parental unit 11. The child may operate a control thereon to alert the user of the parental unit 11 that the child is lost, or if the child otherwise wishes to communicate with the user of the parental unit.

The parental unit 11 further includes one or more controls 23 thereon, such as push-buttons, switches, or dials, among other input means. The controls 23 allow the user to adjust the settings of the device and allow the user to operate the device. The controls 23 allow the user to adjust the volume of the speakers 21 or the input volume of the microphone 22. Additionally, the display 20 may be adapted to show a menu for the operation of the parental unit 11 and the controls 23 may allow the user to scroll through and select menu items on the display 20. A control 23 can be operated so as to contact a child unit so that the user of the parental unit 11 can speak with the child. Further, another control 23 may allow the user to see the video captured by a camera on a child unit.

Referring now to FIG. 2, there is shown a perspective view of an embodiment of the child unit of the present invention. The child unit 12 is adapted to be worn on the wrist of a child. Thus, the child unit 12 preferably comprises a bracelet 15 having a locking fastener 16 thereon. The bracelet 15 is preferably composed of a flexible, durable, and cut-proof material. This helps to prevent the child or another person from removing or breaking the bracelet 15. The child unit 12 includes a microprocessor, a wireless transceiver, a GPS chip, a camera 14, a microphone 30, a speaker 13, and one or more controls 17 for operating the device. The child unit 12 is also adapted to enclose a power source therein.

The child unit 12 includes a video camera 14 thereon for sending a live video of the user of the child unit 12 to the parental unit. Further, the child can communicate with the user of the parental unit via the microphone 30 and speaker 13 thereon. The audio and video data are transmitted using the wireless transceiver to the wireless transceiver of the parental unit. The child can also operate one or more of the controls 17 in order to send a signal to the parental unit that the child wants to communicate or that the child is lost. Once the control is operated, the alarm may sound on the parental unit notifying the parental unit that the child wants to communicate or that the child is lost.

The child unit 12 includes a GPS chip therein. The GPS chip determines the location of the child unit, and the wireless transceiver is adapted to send the location information to the parental unit. The location information can include the coordinates of the GPS chip in the child unit, or the child unit's location can be displayed on a map of the nearby area. In this way, the user can easily determine the location of a child.

The child unit 12 further comprises a locking fastener 16 thereon. The locking fastener 16 allows the child unit 12 to be secured on the child's wrist. The locking fastener 16 allows a parent or guardian to secure the child unit 12 to the child so that it cannot be removed. This prevents the child from removing the child unit 12 and becoming lost, and also prevents another party, such as a kidnapper, from removing the child unit 12 from the child in order to avoid being tracked or located.

The locking fastener 16 can include a lock that is openable using a key. Alternatively, the locking fastener 16 may be an electronic lock that is adapted to be wirelessly locked or unlocked via the parental unit. The parental unit is adapted to allow a user to transmit a wireless signal to the child unit to either lock or unlock the child unit. The parental unit may have a control dedicated to performing this function. The child unit receives the signal and locks or unlocks the locking fastener 16, depending upon the signal sent by the parental unit. Preferably, the parental unit must be in close proximity to the child unit in order to unlock the same. This helps to prevent accidental unlocking of the child unit and helps to ensure that the child is wearing the child unit unless the child is in the presence of a parent or guardian. In alternate embodiments, the locking fastener 16 may include a biometric lock that requires authentication of a user's fingerprint in order to open the locking fastener 16.

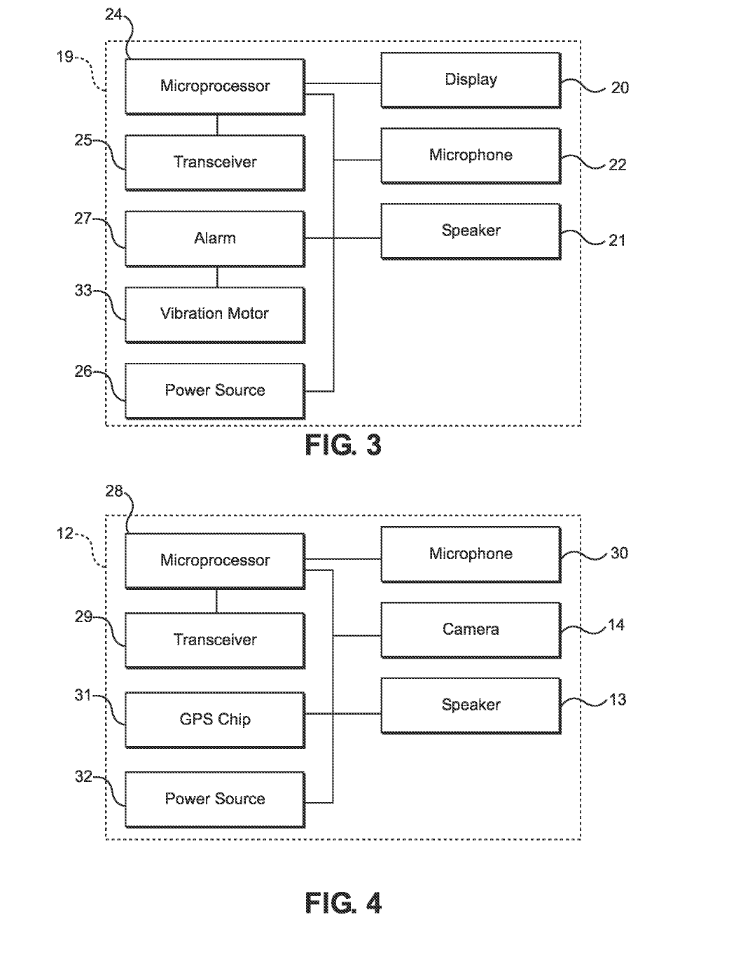

Referring now to FIG. 3, there is shown a schematic diagram of the parental unit of the present invention. The parental unit comprises a housing 19 having a microprocessor 24 operably connected to a wireless transceiver 25. The parental unit is powered by a power source 26, such as one or more batteries. The parental unit can send signals to and receive signals from a child unit paired therewith. The housing 19 of the parental unit further includes a display 20 for displaying information regarding the location of the child unit. The display 20 may also display a menu for adjusting settings and allowing the user to control the operation of the parental unit. The parental unit includes a microphone 22 and speaker 21 for allowing the user to audibly communicate with the user of the child unit. The parental unit further includes an alarm 27 that provides the user of the parental unit with notifications as to the status of the child, and indicates if the child is attempting to reach the user of the parental unit. It is contemplated that the alarm 27 may comprise a visual alerts, audible alerts, or vibrations, depending upon embodiment. Thus, the display 20 may comprise a backlight that is adapted to illuminate or flash to provide a visual alert. Additionally, the alarm 27 may be in electrical connection with a vibration motor 33 that is adapted to vibrate the housing 19 of the parental unit.

Referring now to FIG. 4, there is shown a schematic diagram of the child unit of the present invention. The child unit 12 comprises a microprocessor 28 operably connected to a wireless transceiver 29. The transceiver 29 is adapted to send and receive signals to the wireless transceiver of the parental unit. The child unit 12 further comprises a GPS chip 31 for determining the location of the child unit 12. The location information can then be wirelessly transmitted to the parental unit 11 via the transceiver 29. The child unit 12 is further adapted to enclose a power source 32 therein, such as one or more batteries. The various components of the child unit 12 are embedded within the bracelet.

The child unit 12 further includes a microphone 30, a camera 14, and a speaker 13. The microphone 30 and speaker 13 allow the user to speak with the user of the parental unit. The camera 14 captures live video that can also be transmitted to the user of the parental unit. Thus, the user of the parental unit can see and communicate with the user of the child unit. This may help the user to determine the location of the child and allows the user to calm the child if the child has become upset as result of becoming lost.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A child monitoring system, comprising:
a parental unit comprising a microprocessor, a wireless transceiver, a display, a microphone, and a speaker;
a child unit comprising a microprocessor, a wireless transceiver, a microphone, a speaker, and a GPS chip;
wherein said parental unit and said child unit are adapted to wirelessly communicate with one another;
wherein said child unit is adapted to transmit location information as determined by said GPS chip to said parental unit, and wherein said location information is displayed on said display.

2) The child monitoring system of claim 1, wherein said parental unit further comprises an alarm adapted to alert a user when said child unit sends a signal to said parental unit.

3) The child monitoring system of claim 2, wherein said alarm comprises a vibration motor for alerting a user of said parental unit.

4) The child monitoring system of claim 1, wherein said parental unit comprises a watch-like device having a housing and an adjustable strap adapted to be secured on the wrist of a user.

5) The child monitoring system of claim 1, wherein said child unit comprises a bracelet removably securable to a user's wrist.

6) The child monitoring system of claim 5, wherein said child unit further comprises a lockable fastener thereon.

7) The child monitoring system of claim 6, wherein said lockable fastener includes an electronic lock adapted to be wirelessly locked or unlocked by means of a signal sent by said parental unit.

8) The child monitoring system of claim 1, wherein said display is adapted to display a map indicating the location of said child unit thereon as determined by said GPS chip of said child unit.

9) The child monitoring system of claim 1, wherein said parental unit further comprises controls for operating said parental unit.

10) The child monitoring system of claim 1, wherein said child unit further comprises controls;
whereby actuating said controls of said child unit activates an alarm on said parental unit.
